(19) United States
(12) Patent Application Publication
(10) Pub. No.: US 2018/0060539 A1
(43) Pub. Date: Mar. 1, 2018

(54) System and method of standard-compliant electronic case report form design and clinical data set generation

(71) Applicant: NATIONAL YANG MING UNIVERSITY, Taipei City (TW)

(72) Inventors: Ching-Heng Lin, Taipei City (TW); Ueng-Cheng Yang, Taipei City (TW); Yang-Cheng Fann, Taipei City (TW)

(21) Appl. No.: 15/470,467

(22) Filed: Mar. 27, 2017

(30) Foreign Application Priority Data
Aug. 29, 2016 (TW) 105127722

(51) Int. Cl. G06F 19/00

(52) U.S. Cl. CPC G06F 19/363; G06F 19/3487

(57) ABSTRACT

In a method of standard-compliant electronic case report form (eCRF) design and clinical data set collection, the steps comprise providing a standard specification document. Then, analyzing the standard specification document to generate a standard-compliant question information by a standard specification analyzer, and transforming the standard-compliant question information to a standard-compliant question object by a standard-compliant question generator. Generating a standard-compliant eCRF by a standard-compliant case report form design interface. Moreover, confirming the standard-compliant eCRFs whether comply with the standard specification by a standard rules validator.

### CROSS-REFERENCE TO RELATED APPLICATIONS

This Non-provisional application claims priority under 35 U.S.C. § 119(a) on Patent Application No(s). [TW105127722] filed in Taiwan, Republic of China [Aug. 29, 2016], the entire contents of which are hereby incorporated by reference.

### FIELD OF THE INVENTION

The invention relates to a system of standard-compliant electronic case report form generation. Particularly, each question in the electronic case report form, which is designed by the system, is in line with the requirements of standard specification.

### BACKGROUND OF THE INVENTION

E-clinical trial is using information technology to support clinical research. It is based on the development of Clinical Trial Management System (CTMS). Similar to the hospital information system (HIS), CTMS is comprised by different subsystems, such as the electronic data capture system, the study subject management system, the regulatory data tabulation system, etc. Broadly speaking, CTMS may also include protocol application and management system used by the Institutional Review Board (IRB).

To ensure the data quality and to facilitate the data integration of a trial, standards are important for electronic CTMS. Clinical data interchange standards consortium (CDISC) has established a series of standards to support the acquisition, exchange, submission and archive of clinical research data and metadata. These data standards include clinical data acquisition standards harmonization (CDASH), study data tabulation model (SDTM), standard for exchange of nonclinical data (SEND) and analysis data model (ADaM), etc., which cover the whole process of clinical trials.

In the United States and most other industrialized countries, government agencies, such as the US food and drug Administration (FDA), strictly regulate drugs and devices. Therefore, pharmaceutical companies need to collect data and to show the safety and effectiveness of a new drug or a medical device.

To run a clinical trial is generally expensive and time-consuming Both patient and the pharmaceutical company sides are eager to know the evaluation results. To speed up the process and reduce costs of the review process, the US regulatory authorities provide data standards for electronic files submission.

People usually transform data into study data tabulated model (SDTM) at the end of a clinical trial in order to comply with standards. This is a time-consuming and error-prone process. Any non-compliant data may result in a delay of the permit application process. Thus, there is a need for simplify the design process. It is better to use the standard forms to collect data from the beginning of a trial. However, few people design case report form based on CDISC standards.

### SUMMARY OF THE INVENTION

The present invention provides a system to generate the standard-compliant electronic case report form (eCRF). This system comprises a standard-compliant eCRF designer module and a standard rules validator. The standard-compliant eCRF designer module further comprises a standard specification analyzer, a standard-compliant question generator and a standard-compliant CRF design interface.

The standard specification analyzer is used to generate a standard-compliant question information by analyzing the standard specification document.

The standard-compliant question generator connected to the standard specification analyzer, is used to transform the standard-compliant question information to a standard-compliant electronic question object.

The standard-compliant case report form design interface connected to the standard-compliant question generator used to generate a standard-compliant eCRF.

The standard rules validator connected to the standard-compliant eCRF designer module, is used to confirm the standard-compliant eCRF whether comply with the standard specification, and adding a linking question to the standard-compliant eCRF.

In accordance with another embodiment, the present invention further provides an assessment method of standard-compliant eCRF generation, the method comprises a) providing a standard specification document.

b) analyzing the standard specification document to generate a standard-compliant question information by a standard specification analyzer.

c) transforming the standard-compliant question information to a standard-compliant question object by a standard-compliant question generator.

d) generating a standard-compliant eCRF by a standard-compliant case report form design interface.

And e) confirming the standard-compliant eCRFs whether comply with the standard specification by a standard rules validator, and adding a linking questions to the standard-compliant eCRF.

Upon examination of following drawings and detailed description, other systems, methods, features, and advantages of the present disclosure will be or become apparent to one with skill in the art. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better to understand with reference to the following drawings. The components in the drawings are not necessarily to scale, emphasis be placed upon clearly illustrating the principles of the present disclosure. Moreover, in the drawings, like reference numerals designate corresponding parts throughout the several views.

FIG. 1 is a block diagram of system of a standard-compliant electronic case report form (eCRF) generation in accordance with various embodiments of the present disclosure.

FIG. 2 is a standard-compliant eCRF designer module in accordance with various embodiments of the present disclosure.

FIG. 3 is a standard-compliant data tabulator in accordance with various embodiments of the present disclosure.

FIG. 4 is a top-level flowchart illustrating examples of the method of standard-compliant eCRF generation in accordance with various embodiments of the present disclosure.

FIG. 5 is a standard-compliant case report form design interface in accordance with various embodiments of the present disclosure.

FIG. 6 is a standard-compliant annotated case report form preview window in accordance with various embodiments of the present disclosure.

FIG. 7 is a trial scheduling module interface in accordance with various embodiments of the present disclosure.

### DETAILED DESCRIPTION OF THE INVENTION

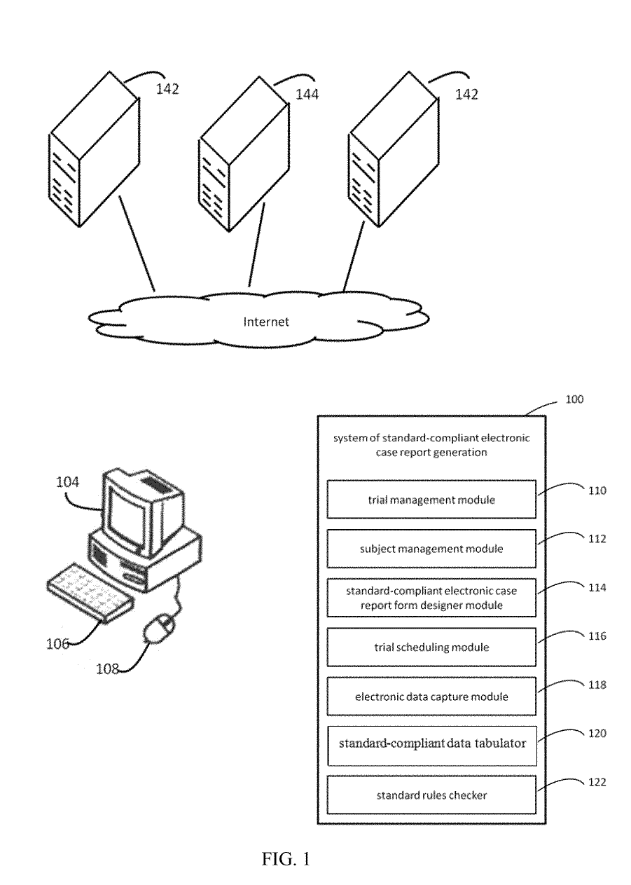

The FIG. 1 illustrates a system of standard-compliant electronic case report form (eCRF) generation in accordance with various embodiments of the present disclosure.

The steps of present invention may include application specific software which may store in any portion or component of the memory including, for example, random access memory (RAM), read-only memory (ROM), hard drive, solid-state drive, magneto optical (MO), IC chip, USB flash drive, memory card, optical disc such as compact disc (CD) or digital versatile disc (DVD), or other memory components.

The system of standard-compliant eCRF generation 100 is any one of a wide variety of wired and/or wireless computing devices, such as a desktop computer, portable computer, dedicated server computer, multiprocessor computing device, cellular telephone, personal digital assistant (PDA), handheld or pen based computer, embedded appliance, or other devices with input/output interfaces, and so forth.

The system of standard-compliant eCRF generation 100 comprises a trial management module 110, a subject management module 112, a standard-compliant electronic case report form designer module 114, a trial scheduling module 116, an electronic data capture module 118, a standard-compliant data tabulator 120 and a standard rules validator 122. The system of standard-compliant eCRF generation 100 further comprises a display 104 and may include such input devices as a keyboard 106 and a mouse 108.

The trial management module 110 provides functions apply to trial protocol, administration and management. For example, the trial management module 110 establishes a clinical trial protocol and is generally used by the protocol review committee to review the clinical trial protocol. The subject management module 112 provides functions of subject recruitment, tracking and management.

The trial scheduling module 116 arranges a schedule of trial protocol and data collection project. Furthermore, the trial protocol data is provided to the electronic data capture module 118, wherein trial protocol data of subject need be collected in a point in time trial. The electronic data capture module 118 assists user for clinical trial data collection from clinical case report forms by the standard-compliant eCRF designer module 114.

A clinical data Warehouse 142, a trial schedule database 144 and an annotated clinical database 148, for example, an optical disc device, a hard drive or a remote server is communicatively via a network. For example, the system of standard-compliant eCRF generation 100 via the network 130 establishes a communication connection with the clinical data warehouse 142, the trial schedule database 144 and the annotated clinical database 148 to transfer data. The network, which may include, for example, the Internet, intranets, extranets, wide area networks (WANs), local area networks (LANs), wired networks, wireless networks, or other suitable networks, etc., or any combination of two or more such networks.

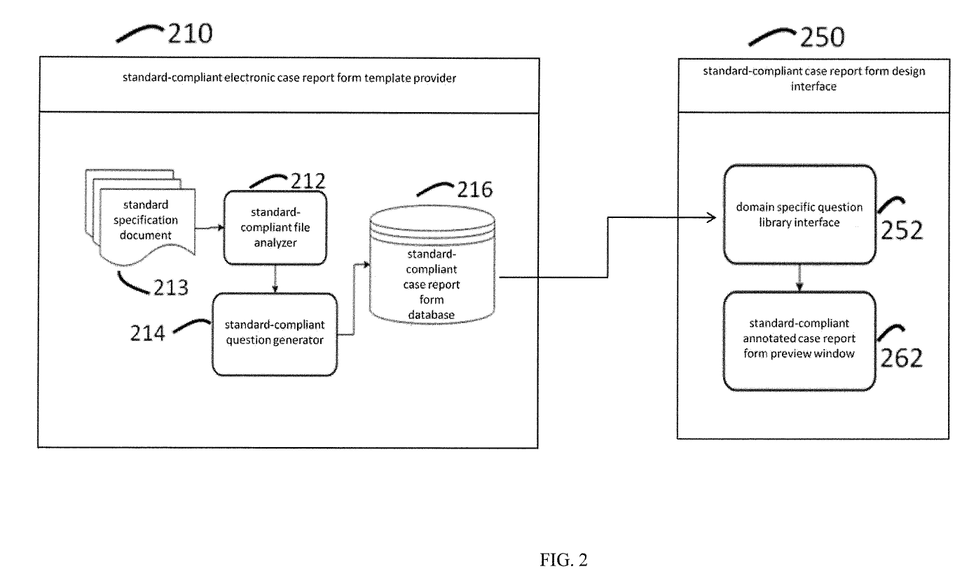

There is a standard-compliant eCRF designer module in accordance with various embodiments of the present disclosure. (FIG. 2) The a standard-compliant eCRF designer module 200 assists user to design clinical case report forms which comply with information standards. The standard-compliant eCRF designer module 200 comprises a standard-compliant eCRF template provider 210 and a standard-compliant case report form design interface 250. The standard-compliant eCRF template provider 210 further comprises a standard specification analyzer 212, a standard specification document 213, a standard-compliant question generator 214 and a standard-compliant case report form database 216. The standard-compliant case report form design interface 250 provides a domain specific question library interface 252 and a standard-compliant annotated case report form preview window 262.

The standard-compliant eCRF template provider 210 provides a clinical form template comply with international standards for the clinical form designer. The clinical form designer invests a new combination of clinical form based on different structural unit of full form, chapter and single clinical question. The standard specification analyzer 212 of the standard-compliant eCRF template provider 210 analyzes the content of standard specification document 213 and provides information needed by the standard-compliant question generator 214 based on converting the content of standard specification document 213. The standard specification document is an extensible markup language or other electronic file format, comprising regulatory authorities' regulations or international standard specifications. The standard-compliant question generator 214 of the standard-compliant eCRF template provider 210 converts data analyzed by the standard specification analyzer 212 to a standard-compliant eCRF object, wherein each clinical question of standard-compliant eCRF object is linked to a standard data element. The standard-compliant case report form database 216 of the standard-compliant eCRF template provider 210 stores results generated by the standard-compliant question generator 214 and provides a search function. The standard-compliant case report form design interface 250 provides user to make a selection of standard question library and the clinical form design and preview. The domain specific question library interface 252 displays content of the standard-compliant case report form database 216 based on different category for user to select. The standard-compliant annotated case report form preview window 262 displays a final annotated form for user to preview.

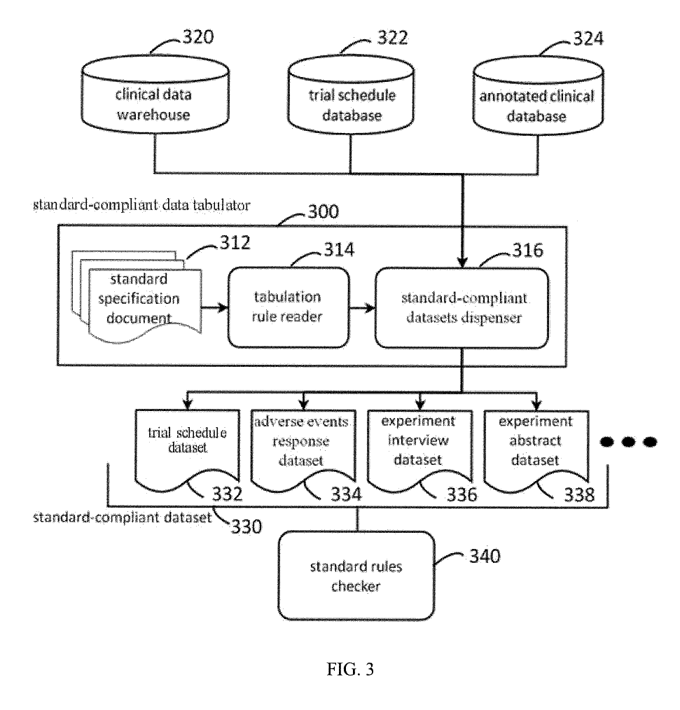

There is a standard-compliant data tabulator in accordance with various embodiments of the present disclosure. FIG. 3 The standard-compliant data tabulator 300 comprises a standard specification document 312, a tabulation rule reader 314 and a standard-compliant dataset dispenser 316. The tabulation rule reader 314 produces tabulation rules after the tabulation rule reader 314 reads the standard specification document 312. The standard-compliant dataset dispenser 316 generates a standard-compliant dataset 330 based on the overall clinical trial data is integrated according to the tabulation rules. The standard-compliant dataset 330 comprises at least one of a subject basic dataset 332, an adverse events response dataset 334, an trial protocol interview dataset 336 and an trial protocol abstract dataset 338. The framework, content, data type and file format of the standard-compliant dataset 330 complies with the specifications determined by an regulatory authority. The standard-compliant dataset 330 comprises at least one of a subject basic dataset 332, an adverse events response dataset 334, an trial protocol interview dataset 336 and an trial protocol abstract dataset 338. The framework, content, data type and file format of the standard-compliant dataset 330 complies with the specifications determined by an regulatory authority.

The system of standard-compliant electronic case report 100 further comprises a clinical data warehouse 320, a trial schedule database 322 and an annotated clinical database 324. The clinical data warehouse 320 integrates of information among the trial information database 326, the study subject database 327 and the standard-compliant case report form database 328, and storing all types and granularity of documents comply with standard specification. The clinical data warehouse 320 comprises the trial information database 326, the study subject database 327 and the standard-compliant case report form database 328. The trial information database 326 stores application and administration information of clinical trial protocol, wherein a table schema and data types of the application and administration information of clinical trial protocol comply with international standards. The study subject database 327 stores the demographic information of the subject. The clinical data warehouse 320 comprises the trial information database 326, the study subject database 327 and the standard-compliant case report form database 328. The trial information database 326 stores application and administration information of clinical trial protocol, wherein a table schema and data types of the application and examination information of clinical trial protocol comply with international standards. The study subject database 327 stores the demographic information of the subject. The standard-compliant case report form database 328 is a storage unit as a question library for the standard-compliant eCRF designer module 114 which used by an electronic data capture module 118. The storage unit stores all kinds of files which file format comply with an international standard, for example, an operational data model or a portable document format. The annotated clinical database 324 stores clinical trial data, wherein the clinical trial data are collected from clinical case report forms and comply with information standards. A standard rules validator 340 checks the standard-compliant eCRFs in the standard-compliant case report form design interface 250 whether comply with the standard specification. The standard rules validator 340 as an external data logical check unit for checking the standard-compliant eCRFs whether comply with the standard specification. Furthermore, the standard rules validator 340 checks results generated by the standard-compliant data tabulator 300.

The trial information database 326, the study subject database 327, the standard-compliant case report form database 328, the trial schedule database 322 and the annotated clinical database 324, for example, an optical disc device, a hard drive or a remote server is communicatively via a network.

For example, the standard-compliant data tabulator 300 via the network establishes a communication connection with the trial information database 326, the study subject database 327, the standard-compliant case report form database 328, the trial schedule database 322 and the annotated clinical database 324 to transfer data. The network, which may include, for example, the Internet, intranets, extranets, wide area networks (WANs), local area networks (LANs), wired networks, wireless networks, or other suitable networks, etc., or any combination of two or more such networks.

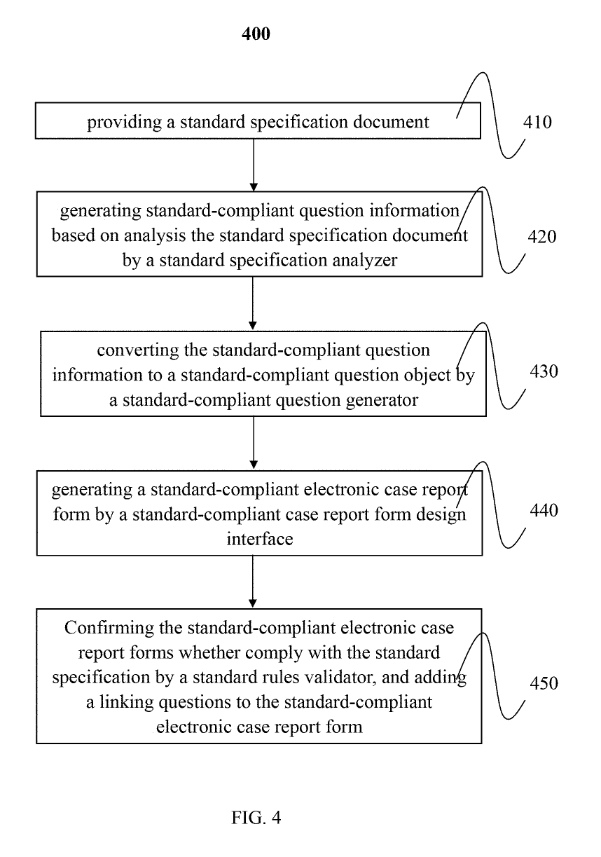

There is a flowchart (FIG. 4) in accordance with various embodiments for generating a standard-compliant electronic case report performed by the computing device of FIG. 1. It is understood that the flowchart of FIG. 4 provides merely an example of the different types of functional arrangements that may be employed to implement the operation of the various components of the computing device. As an alternative, the flowchart of FIG. 4 may be viewed as depicting an example of steps of a method implemented in the computing device according to one or more embodiments.

Although the flowchart of FIG. 4 shows a specific order of execution, it is understood that the order of execution may differ from that which is depicted. For example, the order of execution of two or more blocks may be scrambled relative to the order shown. Also, two or more blocks shown in succession in FIG. 4 may be executed concurrently or with partial concurrence. It is understood that all such variations are within the scope of the present disclosure.

The flowchart of the FIG. 4 is a method for generation of standard-compliant eCRF generation in accordance with various embodiments of the present disclosure. The method for generation of standard-compliant electronic case report may support any clinical trial management system to help with clinical trial. Please refer FIG. 1 and FIG. 4, a description of clinical trial implementation phase is now described. The clinical trial implementation phase can be separated into four-phases comprising an trial protocol design application phase, an trial protocol sheet design phase, a data collection phase and a data tabulation phase.

In the trial protocol design application phase, a project moderator starts an trial protocol plan by using the trial management module 110. The trial management module 110 is generally used by the regulatory committee to review the clinical trial protocol. After the project is passed, the subject management module 112 is used for subject recruitment and management.

In the trial protocol sheet design phase (step 410), the form designer designs a form according to trial protocol purposes by using the standard-compliant eCRF designer module 114. The standard-compliant eCRF designer module 114 assists user to design clinical case report forms which comply with information standards. In step 420, the standard specification analyzer 212 is used by the standard-compliant eCRF designer module 114 to generate standard-compliant question information based on the standard specification document analyze.

In step 430, the standard-compliant question generator 214 converts the standard-compliant question information to a standard-compliant electronic case report object, for example, questions present in a case report form comply with information standards. The standard-compliant question object is saved in the standard-compliant case report form database 216 for the form designer to select. The question library is provided to design case report form which has been adopted by many of today's other systems. However, the system and method of standard-compliant eCRF generation provides a standardized questions present in a case report form to save time for the case report form design.

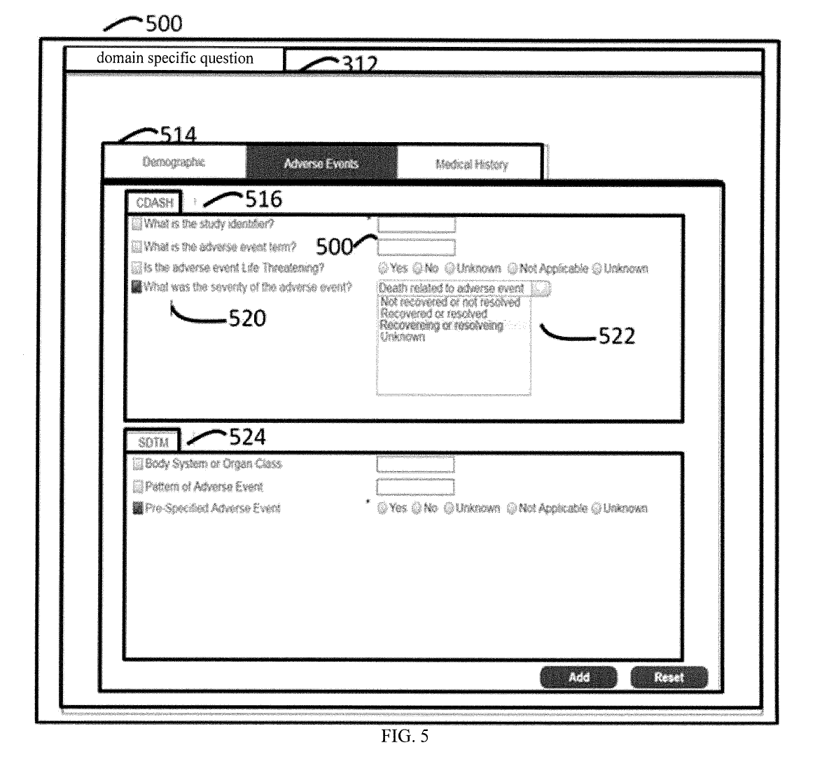

There is a standard-compliant case report form design interface in accordance with various embodiments of the present disclosure (FIG. 5). In step 440, the design a standard-compliant eCRF. The standard-compliant case report form design interface 500 provides user to make a selection of standard question library, the clinical form design and preview.

User selects different categories of the standard-compliant case report form database 216 based on label 514 switch in the standard-compliant case report form design interface 500 to generate the standard-compliant eCRF. Clinical questions in each standard-compliant eCRF is generated based on different standards and classification 516, 524 displayed to users.

Each wording of clinical question complies with standard document suggestion 520. The menu follows controlled term specification 522 in the standard book. For example, the standard-compliant eCRF is generated by the system of standard-compliant electronic case report, which further provides wording options accepted by the regulatory authority, for example, man, woman and intersex not male, female or other synonyms.

The strike symbol 518 pointing in the clinical data represents necessity when the clinical data submitted for review as requested item, wherein at least one of problems in the standard-compliant eCRF linked to standard data element is added by the standard rules validator.

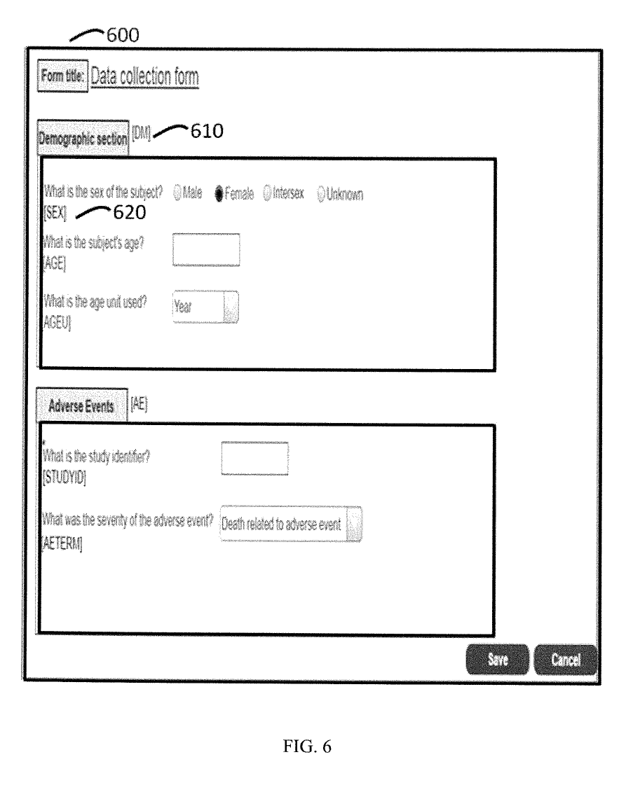

Reference is made to FIG. 6, which is a standard-compliant annotated case report form preview window in accordance with various embodiments of the present disclosure. The standard-compliant annotated case report form preview window 600 displays a final design result for preview based on the standard question added by user selection. Each clinical field in the case report form is shown as an abbreviation 610. Each question 620 is linked to a standard data element and displayed in the standard-compliant annotated case report form preview window 600. In the design process, the standard rules validator 340 runs in the background operation for checking questions, fields and options in the standard-compliant eCRFs whether comply with the standard specification.

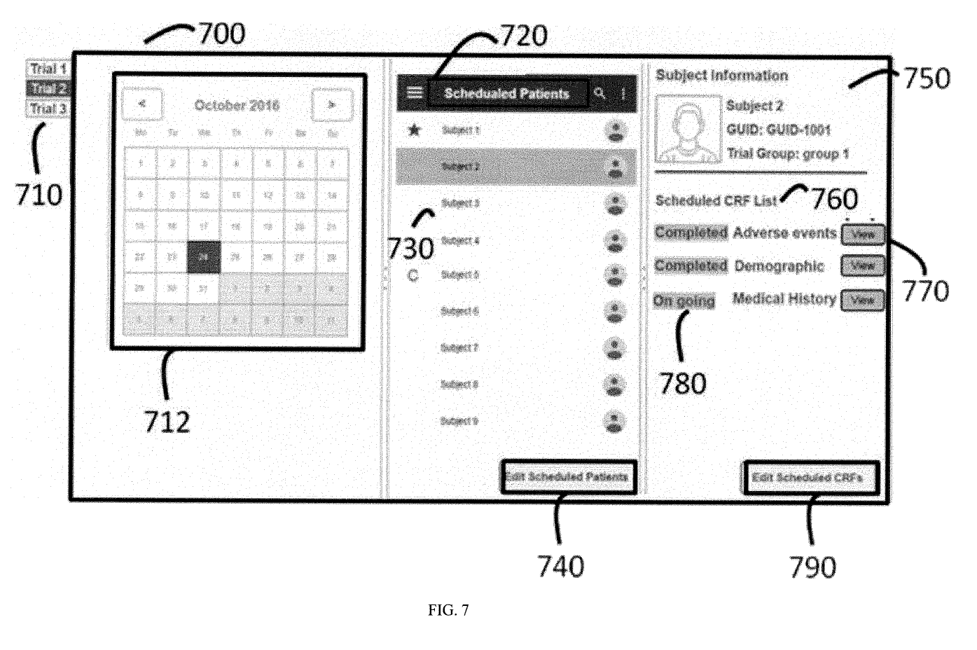

There is a trial scheduling module interface in accordance with various embodiments of the present disclosure FIG. 7. In the data collection phase, the researcher arranges a schedule of trial protocol and data collection project by using the trial scheduling module interface 700. User uses switch label 710 switch between different trial protocols. An electronic calendar 712 provides an trial protocol schedule. The trial scheduling module interface provides a subject available schedule list of a single day by click on the date of the electronic calendar 712. Each symbol mark 730 shows individual state subjects in trial protocol. A list of subjects schedule is able to edit by click edit schedule patients button 740. The Subject information 750 and the schedule case report form list 760 is provided by click a signal subject in the trial scheduling module interface 700. The state of patient 780 and a preview button 770 are displayed. The schedule case report form is able to edit by click the edit schedule CRFs button 790. After completion of the trial protocol schedule, clinical trial data are collected by the electronic data capture module 118. The standard rules validator 340 checks data collection results.

In step 450, the standard rules validator 340 checks the standard-compliant eCRFs whether comply with the standard specification. In data tabulation phase, after completion of the trial protocol, research data is integrated with the standard data elements associated with the research data by the standard-compliant data tabulator 300 then assigns to different datasets based on the international standards. The content, file format, file name, name of variable, definition of variable, type of data, data code, range of data and other information of datasets comply with the standard specification. The standard rules validator 340 provides for final verification.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system of standard-compliant electronic case report form (eCRF) generation, comprises:
a standard-compliant eCRF designer module, is used to obtain a standard specification document, comprising a standard specification analyzer, a standard-compliant question generator and a standard-compliant case report form design interface;
the standard specification analyzer, is used to generate a standard-compliant question information by analyzing the standard specification document;
the standard-compliant question generator connected to the standard specification analyzer, is used to transform the standard-compliant question information to a standard-compliant electronic case report object; and
the standard-compliant case report form design interface connected to the standard-compliant question generator, is used to generate a standard-compliant eCRF; and
a standard rules validator connected to the standard-compliant eCRF designer module, is used to add a linking question to the standard-compliant eCRF and confirm the standard-compliant eCRF whether comply with the standard specification.

2. The system of claim 1, wherein the standard-compliant question generator further comprises a standard-compliant question database, is used to store the standard-compliant question object and provide inquiry function.

3. The system of claim 1, wherein the standard-compliant case report form design interface further comprises a domain specific question library interface, is used to display the content of standard-compliant question object based on different categories.

4. The system of claim 1, wherein the standard-compliant case report form design interface further comprises a standard-compliant annotated case report form preview window, is used to display a final comment form for user to preview.

5. The system of claim 1, further comprises a standard-compliant data tabulator, is used to manage an overall clinical trial data to produce a submission document based on the standard specification document following regulatory authority policy.

6. The system of claim 1, wherein the standard specification document is an extensible markup language or an electronic file format, wherein the electronic file format comprises content definition, variable range or data type of a clinical data acquisition standard, a study data tabulation model, a non-clinical data exchange standard and an analytical data model of standard data set.

7. The system of claim 5, wherein the standard-compliant data tabulator further comprises a tabulation rule reader, is used to produce a tabulation rule after reading the standard specification document.

8. The system of claim 7, wherein the standard-compliant data tabulator further comprises a standard-compliant dataset dispenser, is used to generate a standard-compliant dataset based on the overall clinical trial data according to the tabulation rule.

9. The system of claim 5, further comprises a trial information database, is used to store an application and an administration information of the overall clinical trial, wherein a table schema and a data type of the application and the administration information is in line with international standards.

10. The system of claim 5, further comprises a study subject database, is used to store a demographic information of subject from the overall clinical trial data.

11. The system of claim 5, further comprises a standard-compliant case report form database, is used to store the standard specification document in line with international format from the overall clinical trial data.

12. The system of claims 9, further comprises a clinical data warehouse, is used to integrate information of the trial information database, the study subject database and the standard-compliant case report form database, and types and granularities of the overall clinical trial data are in line with standard specification.

13. The system of claim 1, further comprises a trial schedule database, is used to store a trial protocol schedule data.

14. The system of claim 1, further comprises an annotated clinical database, is used to store a clinical trial data, wherein the clinical trial data is collected from a plurality of clinical case report forms and relates to a standard data element.

15. A computer-implemented method of standard-compliant eCRF generation, the method comprising
providing a standard specification document;
analyzing the standard specification document to generate a standard-compliant question information by a standard specification analyzer;
transforming the standard-compliant question information to a standard-compliant question object by a standard-compliant question generator;
generating a standard-compliant eCRF by a standard-compliant case report form design interface; and
confirming the standard-compliant eCRFs whether comply with the standard specification by a standard rules validator, and adding a linking questions to the standard-compliant eCRF.

16. The method of claim 15, wherein the standard specification document is an extensible markup language or an electronic file format, wherein the electronic file format comprises content definition, variable range or data type of a clinical data acquisition standard, a study data tabulation model, a non-clinical data exchange standard and an analytical data model of standard data set.

17. The method of claim 15, the computer-implemented method further comprises:
managing an overall clinical trial data to produce an submission document based on the standard specification document following regulatory authority policy.

18. The method of claim 17, wherein the overall clinical trial data further comprises a trial protocol schedule data and a clinical trial data, and the clinical trial data is collected from a plurality of clinical case report forms and relates to a standard data element.

19. The method of claim 15, wherein the standard-compliant eCRF limits word using based on standard specifications.

20. The method of claim 15, the computer-implemented method further comprises:
reading the standard specification document to generate a tabulation rule, and integrating the overall clinical trial data to generate a standard-compliant dataset based on the tabulation rule.
